(19) United States
(12) Patent Application Publication
(10) Pub. No.: US 2013/0005374 A1
(43) Pub. Date: Jan. 3, 2013

(54) METHOD AND APPARATUS FOR PROVIDING SPECTRUM RESERVATION

(75) Inventors: Mikko Aleksi Uusitalo, Helsinki (FI); Jan-Erik Ekberg, Vantaa (FI); Jari-Jukka Harald Kaaja, Jarvenpaa (FI)

(73) Assignee: Nokia Corporation, Espoo (FI)

(21) Appl. No.: 13/171,077

(22) Filed: Jun. 28, 2011

(51) Int. Cl. H04W 72/04

(52) U.S. Cl. 455/509

(57) ABSTRACT

An approach is provided for providing spectrum reservation in cognitive radio information sharing. A cognitive radio spectrum reservation platform determines information regarding at least one predicted location of at least one device. The cognitive radio spectrum reservation platform also processes and/or facilitates a processing of the information to generate a prediction of one or more cognitive radio resources that are to be used by the at least one device at the at least one predicted location. The cognitive radio spectrum reservation platform further causes, at least in part, a reservation of the one or more cognitive resources from one or more cognitive radio connectivity providers based, at least in part, on the prediction.

### BACKGROUND

Mobile devices with various methods of connectivity are now for many people becoming the primary gateway to the internet and also a major storage point for personal information. This is in addition to the normal range of personal computers and furthermore sensor devices plus internet based providers. Combining these devices together and lately the applications and the information stored by those applications is a major challenge of interoperability. This can be achieved through numerous, individual and personal information spaces in which persons, groups of persons, etc. can place, share, interact and manipulate (or program devices to automatically perform the planning, interaction and manipulation of) webs of information with their own locally agreed semantics without necessarily conforming to an unobtainable, global whole.

Furthermore, in addition to information, the information spaces may be combined with webs of shared and interactive computations or computation spaces so that the devices having connectivity to the computation spaces can have the information in the information space manipulated within the computation space environment and the results delivered to the device, rather than the whole process being performed locally in the device. It is noted that such computation spaces may consist of connectivity between devices, from devices to network infrastructure, to distributed information spaces so that computations can be executed where enough computational elements are available. These combined information spaces and computation spaces often referred to as computation clouds, are extensions of the ‘Giant Global Graph’ in which one can apply semantics and reasoning at a local level.

Networks composed of mobile and immobile devices associated with the wide spectrum of distributed information and computation spaces communicate with each other via methods of connectivity based on various paradigms of communication (or radio) such as, for example, cognitive radio wave, telephony, fiber optics, orbiting satellites, the Internet, etc. A recent development in radio communication technology referred to as “cognitive radio” provides a paradigm for wireless communication in which either a network or a wireless node changes its transmission or reception parameters to communicate efficiently while avoiding interference with other users, either licensed or unlicensed. In one embodiment, this alteration of parameters is based, at least in part, on the active monitoring of several factors in the external and internal radio environment, such as radio frequency spectrum, user behavior and network state. By way of example, cognitive radio can provide many advantages over traditional radio communication paradigms, for example, by (1) enabling use of all available frequencies leading to efficient use of the radio spectrum, (2) providing each user with the optimal connectivity for the use and the occasion, (3) providing easy access control and identification management, (4) providing new levels of interaction among various radio types, etc. Because of the benefits of cognitive radio, many network managers may opt for using cognitive radio as their preferred way of communication. These and other advantages of cognitive radio connectivity can provide optimal connectivity according to time, place, situation, user needs, applications used, etc.

Since the cognitive radio technology is becoming more flexible and dynamic and user needs for radio spectrum varies in time and place, it is valuable for spectrum users to know that at a certain place and time in future one would have the spectrum available that one will need for a certain purpose. It is also valuable to be able to navigate to a place and guarantee availability of (e.g. reserve) spectrum according to travel time and after having arrived at the destination.

### SOME EXAMPLE EMBODIMENTS

Therefore, there is a need for an approach for providing spectrum reservation in cognitive radio information sharing based, at least in part, on or in association with navigation guidance provided at one or more devices.

According to one embodiment, a method comprises determining information regarding at least one predicted location of at least one device. The method also comprises processing and/or facilitating a processing of the information to generate a prediction of one or more cognitive radio resources that are to be used by the at least one device at the at least one predicted location. The method further comprises causing, at least in part, a reservation of the one or more cognitive resources from one or more cognitive radio connectivity providers based, at least in part, on the prediction.

According to another embodiment, an apparatus comprises at least one processor, and at least one memory including computer program code for one or more computer programs, the at least one memory and the computer program code configured to, with the at least one processor, cause, at least in part, the apparatus to determine information regarding at least one predicted location of at least one device. The apparatus is also caused to process and/or facilitate a processing of the information to generate a prediction of one or more cognitive radio resources that are to be used by the at least one device at the at least one predicted location. The apparatus is further caused to cause, at least in part, a reservation of the one or more cognitive resources from one or more cognitive radio connectivity providers based, at least in part, on the prediction.

According to another embodiment, a computer-readable storage medium carries one or more sequences of one or more instructions which, when executed by one or more processors, cause, at least in part, an apparatus to determine information regarding at least one predicted location of at least one device. The apparatus is also caused to process and/or facilitate a processing of the information to generate a prediction of one or more cognitive radio resources that are to be used by the at least one device at the at least one predicted location. The apparatus is further caused to cause, at least in part, a reservation of the one or more cognitive resources from one or more cognitive radio connectivity providers based, at least in part, on the prediction.

According to another embodiment, an apparatus comprises means for determining information regarding at least one predicted location of at least one device. The apparatus also comprises means for processing and/or facilitating a processing of the information to generate a prediction of one or more cognitive radio resources that are to be used by the at least one device at the at least one predicted location. The apparatus further comprises means for causing, at least in part, a reservation of the one or more cognitive resources from one or more cognitive radio connectivity providers based, at least in part, on the prediction.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing spectrum reservation in cognitive radio information sharing, according to one embodiment;

FIG. 2 is a diagram of the components of a cognitive radio spectrum reservation platform, according to one embodiment;

FIG. 3 is a flowchart of a process for providing spectrum reservation in cognitive radio information sharing, according to one embodiment;

FIGS. 4A-4B are diagrams of data exchange for providing spectrum reservation in cognitive radio information sharing, according to various embodiments;

FIG. 5 is a diagram of spectrum reservation for various activity types, according to one embodiment;

FIG. 6 is a diagram of using cloud environment for sharing cognitive radio information, according to one embodiment;

FIG. 7 is a diagram of mapping between cloud environment and cognitive radio environment, according to one embodiment;

FIG. 8 is a diagram of an information space architecture used for providing cognitive radio information sharing, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing spectrum reservation in cognitive radio information sharing are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

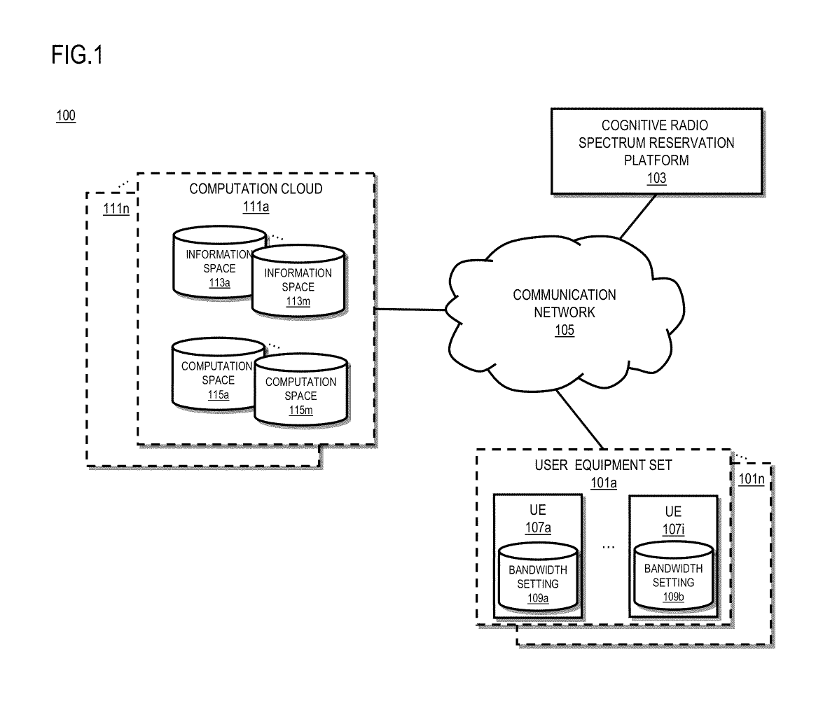

FIG. 1 is a diagram of a system capable of providing spectrum reservation in cognitive radio information sharing, according to one embodiment. Under traditional radio communication protocols, mobile devices generally are limited to using certain frequencies for communication which may cause high network traffic. For example, new music and video services on the Internet may require far more bandwidth than is available on the networks. As noted above, cognitive radio technology can be used to overcome some of the limitations of traditional wireless communications. For example, cognitive radio enables the devices to use all available frequencies even those dedicated to special services such as, for example, television (TV), satellites, etc. to support communications. More specifically, cognitive radio devices typically determine locally available radio spectrum and then negotiate with each other and/or with network management components in order to use the available radio spectrum in the most efficient way.

In one embodiment, cognitive radio may provide the possibility to multiply the current network speeds and/or capacity. For example, cognitive radio technology can be configured to understand the language of any radio protocol. This characteristic of the cognitive radio, combined with new simple radios embedded in any object, can provide interaction between any physical objects. This can also provide solutions for communication between people using communication devices with different setups, such as for example, different languages and cultures, etc.

For example, at a big event such as a concert or a sports event the local network may get overloaded. Based on the current spectrum usage limitations, the provided capacity may not be enough for all the users. In one embodiment, cognitive radio technology can use all available frequencies and connectivity methods. It can quickly adapt to the unusual situation and ensure proper operation of the networks. The devices can connect not only through the network cells, but also by forming spontaneous networks. This enables many more users to transmit information such as, for example, messages, phone calls, real time video streams, etc.

Furthermore, the cognitive connectivity and radio communication paradigm generally provides and/or relies on location dependent information on available bandwidth, rules, and tuning setups associated with a communication network. Accordingly, a cognitive radio enabled system is often equipped with one or more centralized databases in addition to local coexistence management for every device to interact and request operational parameters. More specifically, cognitive radio enabled devices can request and/or inform their (spectrum) findings to the cognitive radio database and local coexistence management, and in return receive settings and other response information to configure devices and utilize settings correctly at certain locations, which are under certain regulations.

However, a user of cognitive radio connectivity may have certain connectivity requirements under certain circumstances, for example during events, in specific locations, at certain time interval, etc. In order to ensure connectivity for the users based on their needs, it is valuable to ensure spectrum availability at a certain place and time in future or, in other words, reserve spectrum for the users based on location, time, type of use, etc. Furthermore, it will be beneficial to the user if spectrum can be reserved according to a travel plan by navigating the travel route so that proper type of connectivity can be provided for the user along the way and after arriving at the destination.

To address this problem, a system 100 of FIG. 1 introduces the capability to provide spectrum reservation in cognitive radio information sharing. The amount of exchanged wireless data is expected to rise to more than a hundred folds in the next 5 years. This rapid increase suggests that, in near future, spectrum availability will become scarce and therefore it will be very valuable, or in some circumstances necessary, to be able to reserve spectrum. In one embodiment, it is contemplated that the reservation may be made “positively” whereby needed spectrum resources are designated or otherwise identified for reservation. In addition or alternatively, the reservation may be made “negatively” whereby the spectrum resources that are not needed can be specified. Under this “negative” approach, the system 100 assumes that any resources not specified would be needed and a reservation for the unspecified resources is made.

In one embodiment, the spectrum reservation may not just influence the priority for admission control for cognitive radio use in the next location or guarantee controlled access, but to actually reserve spectral area in advance for specific users, activities, etc. according to time, date, etc. In one embodiment, the spectrum reservation can be combined with navigation so that future spectrum needs are predicted and proper spectrum can be prepared for future use based on the prediction. Furthermore, collection of information for policing mechanisms in advance provides in advance spectrum reservation.

In one embodiment, each member of a group of users may have a different level of priority for consuming the bandwidth compared to other members, such that requests from users with higher priorities can be processed with higher priority compared to other requests. Each user can send their usage information to a bandwidth allocation entity to reserve resources in cognitive radio domain. Additionally, even within the services of each user, allocation and scheduling of the white space resources may be affected by the type of service requested. For example, different types of media, content, etc. may need different levels of channel Quality of Service (QoS).

In one embodiment, the cognitive radio spectrum reservation platform 103 collects relevant information, such as for example, devices belonging to the group, from all the group members. The cognitive radio spectrum reservation platform 103 may also need input from all devices determining the spectrum needs and preferences for each device. The information may be provided beforehand, provided periodically, provided collectively for one or more users, one or more services, at one or more times, in one or more locations, etc.

In one embodiment, users can collectively navigate and reserve their spectrum needs based on their collective needs during the travel and after the travel, at their destination, including communication between the users. For example, a user that needs to download music while travelling and run a code (e.g. a tool) at the destination can reserve spectrum for both types of use before the trip.

As shown in FIG. 1, the system 100 comprises sets 101a-101n of user equipments (UEs) 107a-107i having connectivity to the cognitive radio spectrum reservation platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), close proximity radios (e.g., NFC), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the communication network 105 and the cognitive radio spectrum reservation platform 103 are different entities, such that the cognitive radio spectrum reservation platform 103 can provide reservation services for various networks, with different types of connectivity that may not be related in any other way. In other words, the cognitive radio spectrum reservation platform 103 may not use a network protocol for reservation, but instead an interface to communicate with network protocols associated to one or more communication networks 105.

In one embodiment, the spectrum reservation platform 103 may repeat reservation process periodically or for as long as pre-determined conditions are met.

In one embodiment, the cognitive radio spectrum reservation platform 103 provides reservation of certain amount of spectrum, or spectral capacity, for a certain purpose (e.g. media download, data intensive transactions, process intensive transactions, etc.) at a certain location (e.g. physical location), for a certain time, or time period, in the future.

It is noted that, a navigation system is an expert system that may be a stand-alone device (e.g. a car navigator) that produces an array of waypoints for the future. Today, complex car navigators interact with servers and other navigators to dynamically alter routes based on traffic jams, police checkpoints, accumulated data of traffic status over time, accidents, road repairs, etc. Therefore, a navigator system provides a dynamic one-to-one mapping with the physical location that the user needs to reserve a resource from. This concerns not only one user, but everybody with navigators, for example the whole population that reserves whitespace resources, are instructed by the navigation systems to physically route and reroute. Therefore, combining the functionalities of navigation system with the spectrum can facilitate users' efforts to reserve services in a manner where everybody can receives the specific services they need, at the right time and place.

In one embodiment, the cognitive radio spectrum reservation platform 103 enables users to combine spectrum reservation with their navigation systems by having their device to request spectrum reservation according to their navigational needs before a travel (e.g. attached to a travel ticket), during the travel, after the travel, at the destination, etc. Additionally, the user device may request spectrum reservation according to the expected travel route, related timing, specific needs for use at any step of the travel, etc.

In one embodiment, when an unexpected and unplanned route change takes place, the cognitive radio spectrum reservation platform 103 may provide spectrum reservation first based on available spectrum (for the defined first timeslot period), before the cognitive radio system is able to provide next quality level guaranteeing the spectrum reservation for the new route.

In one embodiment, if one or more users decide to leave a group, the collective navigation and spectrum reservation can be partitioned so that the departing members of the group can start handling their own navigation and reservation requests. Additionally, when one or more users join a collectively organized navigation and spectrum reservation, the new users will receive their share of the already negotiated portion of the spectrum. A new user may also request an additional bandwidth (e.g. 10%, 25%, 50%, etc.) on top of the already negotiated and reserved spectrum. The additional bandwidth will be assigned to the requesting user if the cognitive radio system has sufficient spectrum available.

In one embodiment, negotiation for spectrum assignment between users (via UEs 107a-107i) and the cognitive radio spectrum reservation platform 103 can be done periodically, for example, for every working day, for travelling on certain more frequently used route, etc.

In one embodiment, a user can generate a constantly repeating request for improvements, in order to receive better services whenever available, for example during travel, at the destination, etc. Furthermore, the cognitive radio spectrum reservation platform 103 may provide reservation waiting lists, so that the users requesting better services can join the waiting lists for upcoming spectrum availabilities for receiving better services. In some embodiments, the cognitive radio spectrum reservation platform 103 may provide upgrade tokens for access to improved services if available. By way of example, upgrade tokens may, for instance, be earned or exchanged based on how many downgrades of previously reserved services have been applied, etc. In other words, in some embodiments, each downgrading of service provides the benefit of have a possible upgrade for future reservations based on spectrum availability.

By way of example, the UEs 107a-107i, and the cognitive radio spectrum reservation platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

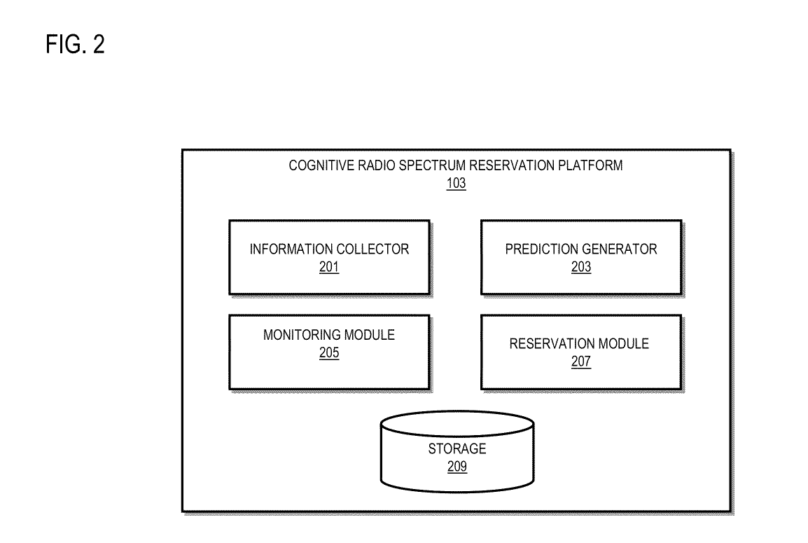

FIG. 2 is a diagram of the components of a cognitive radio spectrum reservation platform, according to one embodiment. By way of example, the cognitive radio spectrum reservation platform 103 includes one or more components for providing spectrum reservation in cognitive radio information sharing. It is contemplated that the functions of these components may be combined in one or more components or performed by other components of equivalent functionality. In this embodiment, the cognitive radio spectrum reservation platform 103 includes an information collector 201, a prediction generator 203, a monitoring module 205, a reservation module 207, and a storage 209.

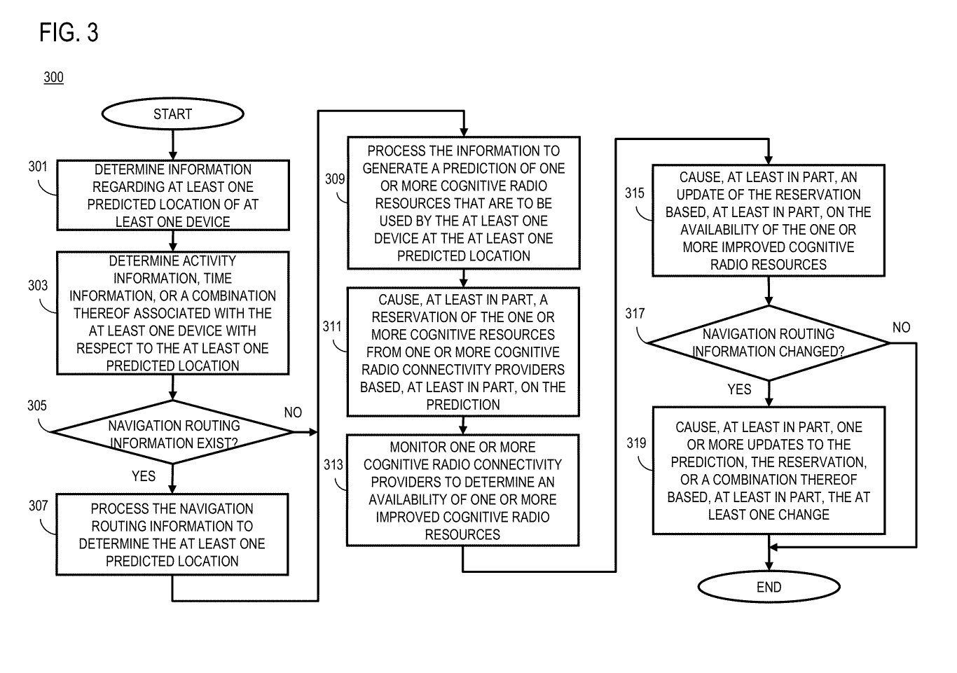

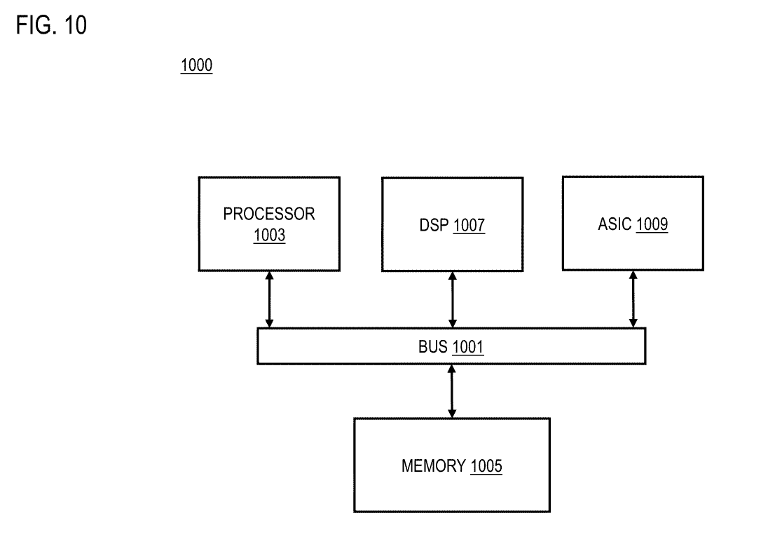

FIG. 2 is described with reference to FIG. 3, wherein FIG. 3 is a flowchart of a process for providing spectrum reservation in cognitive radio information sharing, according to one embodiment. In one embodiment, the cognitive radio spectrum reservation platform 103 performs the process 300 and is implemented in, for instance, a chip set including a processor and a memory as shown in FIG. 10.

In one embodiment, in step 301 of flowchart 300 of FIG. 3, the information collector 201 determines information regarding at least one predicted location of at least one device. The predicted location information may be retrieved from online calendars associated with the at least one device, from travels planned via navigation services, from hotel reservations, flight tickets, rental car reservations, from event registrations (e.g. conferences, meetings), from email contents, or a combination thereof.

In one embodiment, per step 303 of FIG. 3, the information collector 201 determines other information such as activity information, time information, or a combination thereof associated with the at least one device with respect to the at least one predicted location. For example, if the predicate location is a meeting hall or a classroom, the activity may be determined as a lecture, a talk, a presentation, etc.

In one embodiment, per step 305 of FIG. 3, the information collector 201 determines whether there are navigation routing information associated with the at least one device. If the navigation routing information exist, per step 307, the prediction generator 203 processes the navigation routing information to determine the at least one predicted location. The predicted locations may be one or more travel destinations, on route stops, etc.

In one embodiment, per step 309 of FIG. 3, the prediction generator 203 processes the information regarding the at least on predicted location to generate a prediction of one or more cognitive radio resources that are to be used by the at least one device at the at least one predicted location, for the determined activity, at the determined time. The prediction generator 203 may have lists of resource types for various activity types, for example for video streaming, etc.

In one embodiment, per step 311 of FIG. 3, the reservation module 207 causes, at least in part, a reservation of the one or more cognitive resources from one or more cognitive radio connectivity providers based, at least in part, on the prediction. The prediction generator 203 may obtain information regarding available cognitive radio providers from the storage 209, from the computation clouds 111a-111n (e.g. from information spaces 113a-113m), from other sources via communication network 105, or a combination thereof. The prediction by prediction generator 203, the spectrum reservation by the reservation module 207, or a combination thereof can be further based, at least in part, on the activity information, the time information, or a combination thereof.

Additionally, if the information collector 201 determines that the navigation routing information indicates at least one predetermined routes, the information collector alerts the prediction generator 203 and the reservation module 207 to cause, at least in part, an initiation of the prediction, the reservation, or a combination thereof based, at least in part, on the indication of the at least one or more predetermined routes.

In one embodiment, per step 313 of FIG. 3, the monitoring module 205, causes, at least in part, a monitoring of one or more cognitive radio connectivity providers to determine an availability of one or more improved cognitive radio resources that can be used by the at least one device at the at least one predicted location. The monitoring may be performed continuously until an improved resource (e.g. with higher processing power) is available. Upon the availability of an improved resource, the reservation module 207, causes, per step 315, at least in part, an update of the reservation based, at least in part, on the availability of the one or more improved cognitive radio resources. For example, if a more powerful resource has become available, the reservation module 207 may cancel a previously made reservation for another resource and reserve the more powerful resource instead.

In one embodiment, per step 317 of FIG. 3, the information collector 201 determines whether at least one change to the navigation routing information has occurred. The change may happen due to traffic jams, police checkpoints, and accumulated data of traffic status over time, accidents, road repairs, etc. If the navigation route has changed, per step 319 of FIG. 3, the prediction generator 203 updates the prediction, the reservation module 207 updates the reservation, or a combination thereof based, at least in part, on the at least one change.

In one embodiment, the prediction, the reservation, or a combination thereof are determined collectively for the at least one device. This enables the users of UEs 107a-107i to collectively navigate and reserve spectrum based on their collective needs during and after travel, at their destination, etc. The collective navigation and spectrum reservation may also include communication between the users.

In one embodiment, the reservation is requested by at least a subset of the at least one group of devices. For example, spectrum reservations may be done by some members of a group (e.g. friends in a social networking) on behalf of others, given the authority by the others (e.g. group administrator, leader, etc.).

In one embodiment, the monitoring by the monitoring module 205 is performed periodically, substantially continuously, according to a schedule, on demand, or a combination thereof.

In one embodiment, the spectrum reservation by the reservation module 207 is based, at least in part, on a bidding for the one or more cognitive radio resources.

In one embodiment, the information such as physical map data, navigation routes, etc. can be updated over long intervals (e.g. once every six months), or more frequently as gradual updates (e.g. whenever important updates are detected), or a combination thereof.

In various embodiments, information related to connectivity can be stored in a central database, on one or more local storages or a combination thereof. For example, a central database may be maintained by the cognitive radio provider, on cloud 111a-111n in any of the information spaces 113a-113m or computation spaces 115a-115m, or a combination thereof. Additionally, the local storages can be on server nodes, on UEs 107a-107i, in storage 209, or a combination thereof. Furthermore, the white space database including information on available frequencies that are not used by TV or wireless microphones can be used. In one embodiment, the database management systems, the coexistence managers, or a combination thereof may collect relevant information related to available connectivity and frequencies, locally manage the connectivity and being connected to white space databases, etc.

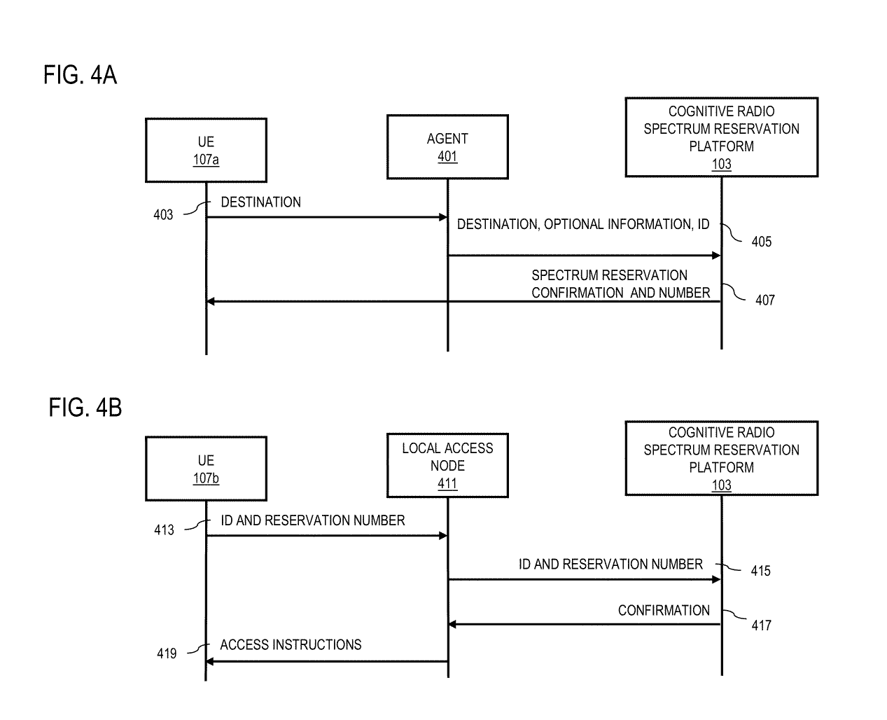

FIGS. 4A-4B are diagrams of data exchange for providing spectrum reservation in cognitive radio information sharing, according to various embodiments. In one embodiment the UE 107a connects to the cognitive radio spectrum reservation platform 103 via an agent 401 by sending the desired destination to the agent 401 via arrow 403. The destination information may include the amount and type of spectrum needed and the time and place that the spectrum is needed at. Additionally, planned destination, planned route, plans for use during travel and at the destination may be provided. The agent 401, that may be located inside or outside of UE 107a adds optional information, such as for example a user ID to the destination information and send the information to the cognitive radio spectrum reservation platform 103. The agent 401 may be continuously running, receiving information from applications associated with the UE 107a and its destination, and convert the information into an expected time and/or place in future. The agent 401 may include the collected information into the optional information and send it to the cognitive radio spectrum reservation platform 103 via arrow 405.

It is noted that the user of UE 107a does not need to know all this information. In one embodiment, a user of UE 107a may provide a destination, time to be spent at the destination and possibly a generic profile they need while on the move and after having arrived at the destination. In some embodiments, when the UE 107a has reached a destination associated with a previously created spectrum reservation, the cognitive radio spectrum reservation platform 103 may re-evaluate the context and spectrum needs of the UE 107a to determine whether any previously determined reservation parameters have changed, whether spectrum needs have increased or decreased, etc. In this way, the platform 103 can release unneeded reservations or request additional spectrum based on the UEs 107 present needs on arrival at a destination.

In one embodiment, a user may also identify other users belonging to the same group. As previously discussed, users may delegate spectrum reservation operation to the group owner, spokesperson, travel agent, etc. In this embodiment, the optional information may include information from other UEs of the group.

In one embodiment, the UE 107a may record how user is using the UE 107a, how other users are using their devices, the environment status (e.g., spectrum and other devices), other available information, or a combination thereof. The UE 107a may also be equipped with some prediction algorithms to be able to better serve the user's spectrum needs in the future.

In one embodiment, the cognitive radio spectrum reservation platform 103 may reserve spectrum based on a first come first serve basis, in the order it receives requests. In other embodiments, the cognitive radio spectrum reservation platform 103 may determine a period of bidding on a price for the spectrum for a certain time before it reserves the spectrum. For example, a highest bidder, fastest bid, first bidder, last bidder, etc. may win the bid and get obtain the spectrum reservation.

In one embodiment, the cognitive radio spectrum reservation platform 103 registers the received information, reserves the spectrum, as discussed, and replies to the UE 107a via arrow 407 with a reservation confirmation and related identification information such as for example a reservation number. The cognitive radio spectrum reservation platform 103 may need to provide separate reservation numbers for every device of a group, when doing group reservations. Additionally, UEs of a group might need to forward their reservation numbers to other UEs in the group.

FIG. 4B shows a process of claiming a reserved spectrum by a UE 107a. In one embodiment, UE 107b, that has arrived at the destination, signals its ID and reservation number to a local access node 411 via arrow 413. Alternately, the UE 107b may send the ID and reservation number directly to the cognitive radio spectrum reservation platform 103.

In one embodiment, the local access node 411 forwards the received reservation number and ID to the cognitive radio spectrum reservation platform 103 via arrow 415. If ID and reservation number are valid, the cognitive radio spectrum reservation platform 103 replies to the local access node 411 via arrow 417 with confirmation and more detailed information about the reservation for the UE 107b. Based on this information, the local access node 411 provides access to the spectrum, according to the reservation, for the UE 107b via arrow 419.

In one embodiment, for group reservation the information collector 201 collects all the relevant information from the group members. The cognitive radio spectrum reservation platform 103 may have access to the list of group members and the needs and preferences of each group member. This information may be provided to the cognitive radio spectrum reservation platform 103 beforehand, provided upon query by the cognitive radio spectrum reservation platform 103 from each device, provided by a representative of all group members, or a combination thereof.

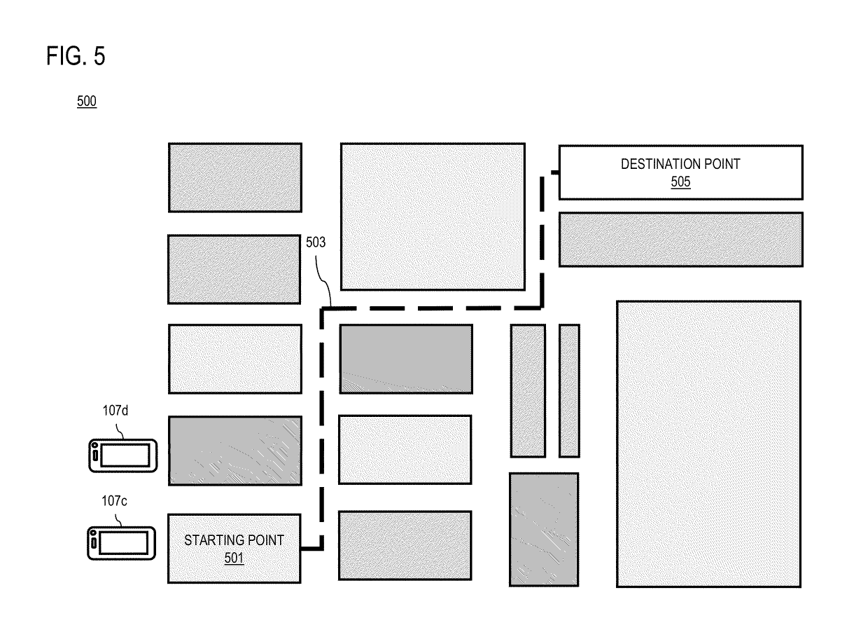

FIG. 5 is a diagram of spectrum reservation for various activity types, according to one embodiment. FIG. 5 shows a map 500 that may be displayed on a User Interface (UI) of a UE 107a-107i. Map 500 represents a planned travel route 503, for example via train, from the starting point 501 to the destination 505 (train stations).

In one embodiment, the user of a UE 107c has reserved spectrum suitable for video downloading while traveling on route 503. The user of UE 107c may have also reserved spectrum at destination 505 to allow run a simulation tool, a game, a software, etc.

In one embodiment, the line 503 and the icon 505, showing the travel route and the destination may be presented to the user in specific colors indicating that the spectrum for video downloading and for software execution is reserved and ready to be used.

In one embodiment, a change of plan, after the reservation is done, may change the color coding accordingly, for example a blinking color may show a change in connectivity, darkening and brightening of the colors may show an attempt by another UE 107d, or by connectivity provider, to overrule the UE 107c's reservation by another user or the connectivity provider.

It is noted that different users may have different behavior on the same route. For example, the user of UE 107c may prefer to be online on the train, while the user of UE 107d may prefer to enjoy the scenery, take a nap if having a chance, or sometimes go online during the trip from point 501 to point 505.

In one embodiment, the user of UE 107c may work during the trip using the cognitive radio enabled UE 107c. The user may have reserved the channel bandwidth in advance via the cognitive radio spectrum reservation platform 103, based on this need for working. However, at some stopping points during the trip the user may need to stop working for some time, for example buy a cup of coffee, and start working again. In this embodiment, the user of UE 107c can start and stop working without losing the chance to continue to work.

In one embodiment, users are UEs 107a and 107b are two colleagues and travel together from point 501 to point 505 every other day and both work online during the trip. In one specific day the train may be unexpectedly crowded and it may affect the connection such that only one of the UEs 107c or 107d can be online at any given time during the trip. In this embodiment, a user of UE 107d may request the cognitive radio spectrum reservation platform 103 to transfer the spectrum reservation credit available on UE 107d to UE 107c (assuming that both UEs have had their reservations for the same service type).

In one embodiment, a user of UE 107c, who has to travel from point 501 to point 505 unexpectedly and without any planning, may need to work on the way. The user should select a travelling method (e.g. bus, train, taxi, etc.) that provides the best connectivity for UE 107c. The user may enter the starting point, destination and departure time into the UE 107c. The UE 107c, via its internal navigator, may provide several options to the user for how to travel. The user of UE 107c may select one or more travelling methods (e.g., taxi, train, and walk) as the desired travel option. In this embodiment, the navigation system may directly communicate with the cognitive radio spectrum reservation platform 103 and the cognitive radio spectrum reservation platform 103 automatically reserve various types of bandwidth for the user for the expected route, along the expected timing, based on the information receiving from the navigation system. For example, the UE 107c may receive suitable connectivity in taxi and in the train (but not during the walk period) enabling the user to work before arriving at the destination 505.

In one embodiment, spectrum reservation may be adapted by the cognitive radio spectrum reservation platform 103 to navigation changes based on, for example, traffic jam or other input information.

In one embodiment, the user of UE 107c may need the cognitive radio spectrum reservation platform 103 to guarantee spectrum for certain applications to be fully available along the route with cognitive radio settings, bandwidth reservation, etc. For example, the user may require that a high definition video call not be interfered, browsing be available without jam, etc. Furthermore, the travelling methods used (e.g., taxi, train, etc.) may set their own requirements and service criteria. The cognitive radio spectrum reservation platform 103 analyzes the information regarding criteria and requirements set by the user, the navigation system, the travelling method, etc. to provide an optimized spectrum reservation for UE 107a that satisfies all criteria and requirements.

In one embodiment, the prediction generator 203 may draw certain patterns from user behavior and use those patterns for further spectrum reservation. For example, if a user of UE 107c travels the same route 503 from point 501 to point 505 on every working day, at about the same time, with almost the same group of people, a pattern for spectrum reservation for the user can be drawn. However, any sudden changes in the behavior can be detected by the information collector 201 and the reservation can be updated as previously discussed with regards to FIGS. 2 and 3.

In one embodiment, the cognitive radio spectrum reservation platform 103 may provide the capability of on-the-spot reservation to a UE 107a. For example, a user may wish to reserve the bandwidth only in certain locations based on need (e.g., where there are best spectrum availability). This can be incorporated in route planning options. For example, the navigation system calculates the fastest route and shows it on a map on the UI of UE 107c. In addition, the cognitive radio spectrum reservation platform 103 provides information to the user on the map about spectrum availability along the route and where the best chances of bandwidth availability are. A message may appear on the screen informing the user that by touching the map at a point on the route the cognitive radio spectrum reservation platform 103 will reserve the bandwidth.

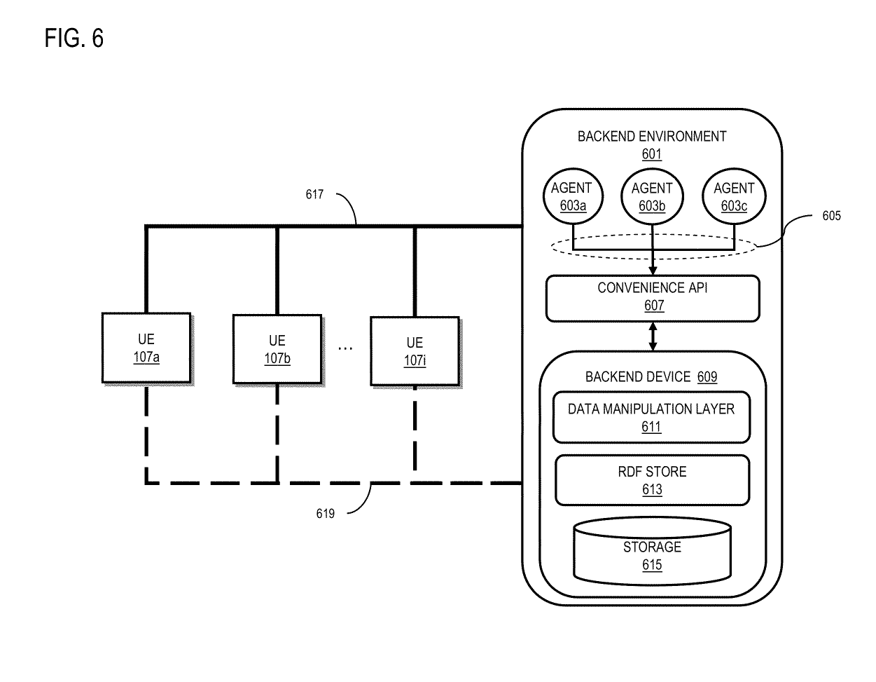

FIG. 6 is a diagram of using cloud environment for sharing cognitive radio information, according to one embodiment. In one embodiment, utilizing cloud environment 111a-111n for sharing cognitive radio information, provides broader information sharing structure than, for example, what WURFL provides. The cognitive radio structure can utilize WURFL as an interoperable service (along with other data sources), wherein the WURFL may access the backend environment 601 and provide direct cognitive radio specific access to UEs 107a, 107b, . . . , 107i with necessary parameters. If information sharing via WURFL fails to extract and provide various cognitive radio parameters such as location, frequencies, etc. any other suitable data sources (service provides) can be utilized to reconstruct such information or derive it from other data.

In one embodiment, the backend environment 601 is a network infrastructure. The backend environment may also be a virtual run-time environment within a cloud 111a-111n associated with the owner of one or more UEs 107a-107i or on another UE 107b associated with the user. The backend environment 601 may include one or more components (backend devices) 609 and one or more Application Programming Interface (API) such as a convenience API 607 that may include APIs tailored to the software development environments used (e.g. JAVA, PHP, etc.). Furthermore, UEs 107a-107i may include client APIs (not shown) each API enabling interaction between devices and components within another device or an environment. For example, the convenience API 607 enables interaction between the backend device 609 and agents 603a, 603b, and 603c, wherein each agent is a set of processes that handle computations within the backend environment 601. Connections 617 and 619 respectively represent distribution paths of data and control among the environment 601 and UEs 107a-107i. The storage 615 is a repository of information and computations that can be accessed and used by all the UEs and infrastructure components having connectivity to the backend environment 601.

In one embodiment, the backend device 609 may be equipped with a data manipulation layer 611 that monitors and manages any access to the storage 615.

In one embodiment, the cognitive radio spectrum reservation platform 103 extracts cognitive radio specific parameters, by sniffing, interrogation, or a combination thereof, from the backend environment 601 associated with cloud 111a-111n and translates the parameters into specific expressions of the cognitive radio. The cognitive radio spectrum reservation platform 103 may also utilize storage 615, which is part of the information space 113a-113m, for storing shared cognitive radio information, white space database, or a combination thereof.

In one embodiment, one or more UEs 107a, 107b, . . . , 107i may request and inform their (spectrum) findings to the common cognitive radio database (e.g. storage 615 in the backend device 609, storage 209 of cognitive radio spectrum reservation platform 103, backend environment 601, or a combination thereof). In response, the backend device 609 may send settings and other response information back to configure UEs 107a-107i. The cognitive radio spectrum reservation platform 103 (shown in FIG. 1) may monitor correct utilization of the received settings by the UEs 107a-107i at certain locations, under certain regulations, etc.

The backend environment 601 may include several layers (e.g. L1, L2, L3) shown as circle 605, which provide fine instruments for developers to access particular layers for development. The layers 605 describe different abstraction layers attached to different convenience layers, convenience API 607. In one embodiment, the cognitive radio functions can be mapped to level L3 as a cognitive radio domain specific API. The cognitive radio domain can be built based on location, frequency and rules information.

In one embodiment, the cloud 111a-111n may have a platform API, which is specific to mobile applications, defining location, bearer, short range communications, etc., and when cognitive radio specific functions (e.g. cognitive radio domain information) are mapped into the platform API, it forms a cognitive radio specific platform API.

In one embodiment, the Data Manipulation Layer (DML) 611 provides connectivity, privacy, security policies API, which will fetch policy rules from storage 615 or any other storage spaces associated with cloud 111a-111n and apply them to the ongoing data-stream.

In one embodiment, the cognitive radio database information, is based on locations wherein each location may be under certain regulations (legislation), allowing certain frequencies to be used at the location.

In one embodiment, as previously described, there may be two options (functions) for cognitive radio specific operations, namely, sniffing (associated radio sensing and listen before talk) such as for example, transmitting, sniffing vacant channels (channel numbers, characteristics); and interrogation (with local agreement). In the interrogation method, the cognitive radio spectrum reservation platform 103 has knowledge of occupied channels and provides protocols for communication among UEs 107a-107i, including rules, candidate neighbors, operation and measurement configurations, etc.

In one embodiment, sniffing includes scanning the environment, whereas interrogation provides more local and global interactions, also selecting the used setup. Sniffing is a subset of interrogation, as interrogation provides more information.

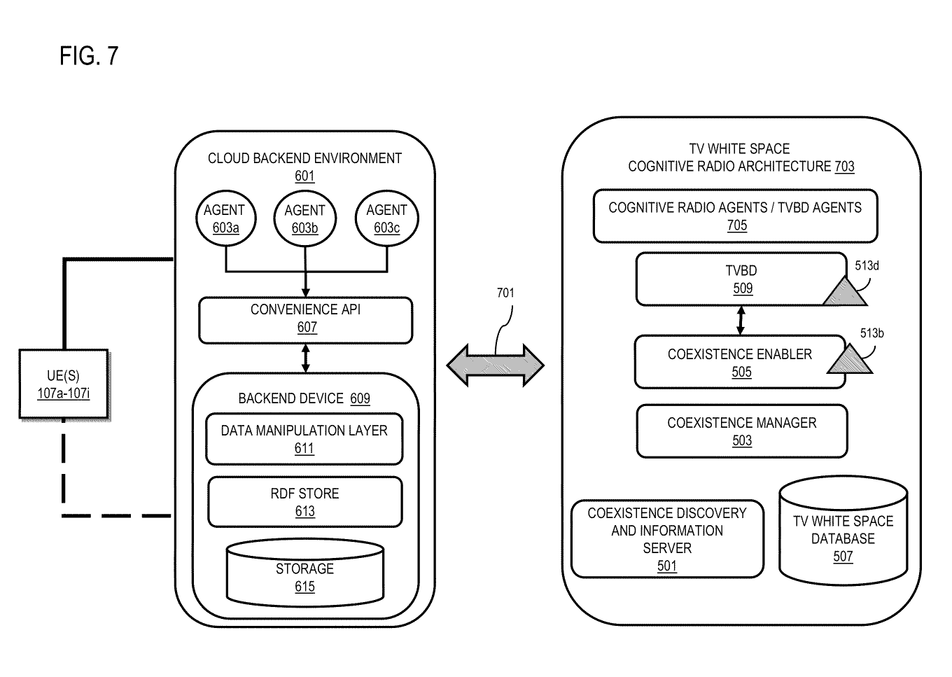

FIG. 7 is a diagram of mapping between cloud environment and cognitive radio environment, according to one embodiment. In one embodiment, the cognitive radio enabled UE 107a-107i requests the cloud backend environment 601 generalized representations, wherein the TV white space cognitive radio architecture 703 is mapped to the backend environment 601 (shown as arrow 701).

In one embodiment, the cognitive radio spectrum reservation platform 103 uses sniffing or interrogation methods and reutilizes the methods in the convenience API 607. The cognitive radio specific API may consist of information such as regulations, bandwidth information and their characteristics, etc. in order to provide cognitive radio specific operations, method of choice (e.g. sniff or interrogate the cognitive radio information from the environment 703).

In one embodiment, mapping 701 is performed on the technologies of the CR architecture environment 703 and the cloud backend environment 601. The cognitive radio functionality information, such as for example location, regulation, frequency, etc. which can be extracted from a cognitive radio specific database (not shown) can be mapped to, for example, platform API, so that the technology map is:

Location (CR)→Location API

Legislation/Regulation (CR)→Connectivity/Privacy/Security Policies API

Frequency (CR)→NEW (or Bearer API)

In one embodiment, the cognitive radio specific API may consist of location API, Connectivity/Privacy/Security Policies API, frequency API or a combination thereof. As seen above, the frequency API may be a new API at the backend environment 601. Alternatively, the frequency can be mapped to a current Bearer API (not shown). The cognitive radio spectrum reservation platform 103 may use sniffing, interrogation or a combination thereof to determine vacant and occupied frequencies with support from cloud environment 601.

In one embodiment, for example, a cognitive radio enabled UE 107a may be associated with a specific location and the connectivity, privacy, security policy rules (API, regulation) with tune up parameters attached to the location. In this embodiment, particular information associated with the location can be extracted from the cloud 111a-111n.

In another embodiment, a cognitive radio enabled UE 107b may be associated with a specific location and the connectivity, privacy, security policy rules (API, regulation) with tune up parameters attached to the location and to a selected frequency. In this embodiment, particular information associated with the location and the frequency can be extracted from the cloud 111a-111n.

In one embodiment, a cognitive radio enabled UE 107c may request direct subscription for device to device communication from location parameters, cloud backend environment Data Manipulation Layer 611 figuring equivalent parameters and enabling these devices to communicate directly. If no DML database exists, a wrapper may be used to provide connection to device storage 615.

In one embodiment, a virtual copy of the local findings and settings of cloud based cognitive radio database can be used at UE level (locally) to allow direct device to device (e.g. UE to UE) cognitive radio connections. The two UEs can form a group in which findings and settings are treated as group findings, and are updated to the backend 601 as well.

In one embodiment, personal or private area settings on a UE 107a may be locally available on a Radio Frequency (RF) memory tag (e.g. home mode, wherein the cognitive radio environment may be more static than other outdoor or public environments), where each cognitive radio enabled UE 107a-107i can pull and push settings for that area from/to RF memory tag. In this embodiment, cognitive radio parameters may be determined periodically or at every touch to the RF memory tag and the determined parameters stored in the RF memory tag for later use and for other UEs to use.

In one embodiment, the privacy enabler 513d and 513b locations in FIG. 7 can be at the edge of the device access to cognitive radio (e.g. between coexistence enabler and TV band device), where privacy policy applied to single device level (about “Me and my data” or “friend” privacy of FIG. 7). Additionally privacy enabler may consist of multiple device privacy policies entering the cognitive radio environment, where privacy policy also takes into account cognitive radio specific coexistence parameters enabling common or separate privacy policies (and privacy zones between those devices). Privacy zone is dependent on cognitive radio location parameter; whether cognitive radio allows computational support to apply certain computational level for this privacy case (e.g. country specific privacy may restrict certain cognitive radio privacy enabler functionality to invalidate particular cognitive radio parameter visibility at that zone, or location).

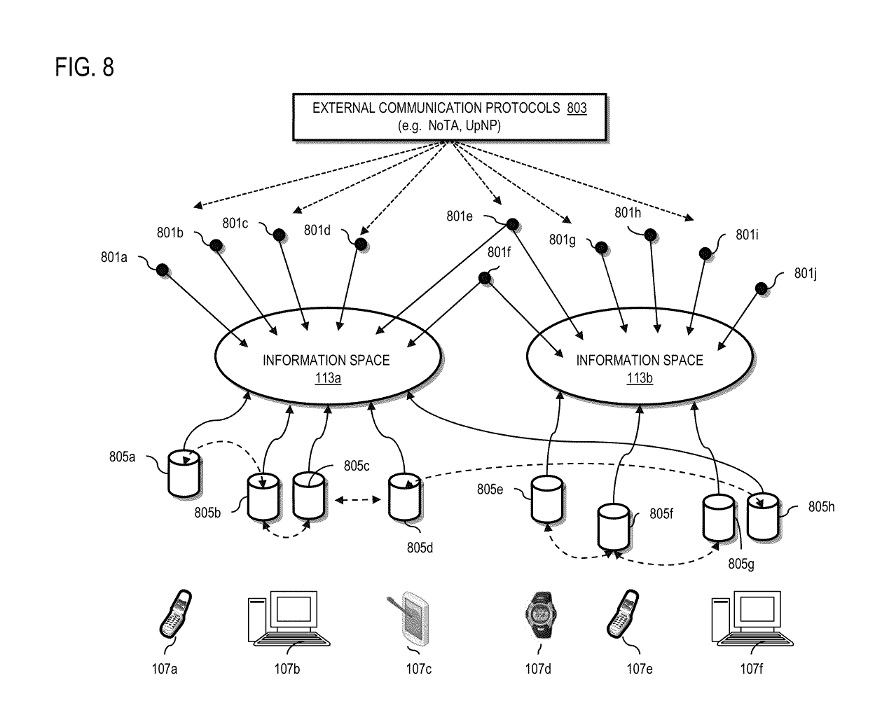

FIG. 8 is a diagram of an information space architecture used for providing cognitive radio information sharing, according to one embodiment. In FIG. 8 two information spaces 113a and 113b are connected to knowledge processors 801a-801j. Some of the knowledge processors such as 801e and 801f are connected to more than one information spaces. In addition, some knowledge processors 801 use external communication protocols 803 outside of the information spaces environment. For example knowledge processors 801c, 801d and 801e may be connected through the NoTA network while knowledge processors 801e, 801g and 801j are connected through UPnP network. The knowledge processors 801a-801j may each consist of components such as user-interfaces, internal logics, connectivity components, etc. (not shown). A knowledge processor 801a-801j may generally run on a single device, even though it may have internal distribution. Such a device may be a mobile device/phone, personal computer, active sensor, Radio Frequency Identification (RFID) tag, etc.

The connectivity component of the knowledge processors 801a-801j (not shown) contains the logic and functionality to communicate to various information spaces 113a-113m. Connectivity is over some network protocol to a semantic information broker (SIB) 805a-805h. A semantic information broker 805a-805h contains the logic for parsing messages and pointers to subscription handlers between the knowledge processors 801a-801j and the information space 113a. A knowledge processor 801a-801j may potentially connect to more than one information spaces at a time thus distributing and synchronizing the operations across all connected information spaces.

The basic functionality provided by the connectivity protocols at this level for manipulating information and for connection to an information space 113a-113m is given below:
Insert: insert information in information space 113a-113m (as an RDF graph) atomically (e.g., at the level of the smallest information element of the information space 113a-113m),
Retract: remove information from information space 113a-113m (as an RDF graph) atomically,
Update: update information on information space 113a-113m (as an RDF graph) atomically—often implemented as a retract and insert through the transaction system,
Query: synchronously (blocking) query; retrieve information from information space 113a-113m,
Subscribe: asynchronously (persistent, non-blocking) set up a subscription to the information space 113a-113m for a given query,
Unsubscribe: terminate a given subscription to information space 113a-113m,
Join: request initiation of an interaction session between a knowledge processor 801 and a given information space 113a-113m,
Leave: terminate the current interaction sessions between a knowledge processor 801 and the information space 113a-113m.

The information space 113a-113m is “virtual” in nature in the sense that its existence is provided by the underlying semantic information brokers 805a-805h which are the elements that “physically” exist. Within the scope of an information space 113a-113m, capabilities for local reasoning over the information contained in that information space are provided through a deductive closure calculation mechanism (not shown). The mechanisms for managing connections and operations of knowledge processors 801a-801j and for distributing the information around information spaces 113a-113m can be implemented by more than one SIB 805 distributed over different processing elements.

The interaction among knowledge processors 801a-801j and information spaces 113a-113m is accomplished by network connections to one or more SIBs 805a-805h providing or representing the information space. As far as the user or designer of a knowledge processor 801a-801j is concerned, there are knowledge processors 801a-801j and information spaces 113a-113m and the connectivity layer abstracts away the physical connection to a SIB 805a-805h.

Additionally the semantic information brokers 805a-805h may be distributed over a number of different devices 107a-107f. For example, SIB 805a is on device 107a and SIBs 805b and 805c are on device 107b. However as seen in FIG. 8 each set of SIBs represent one information space at a time. For example, SIBs 805a-805d and 805h represent information space 113a while SIBs 805e-805g represent information space 113b. Some devices can run more than one SIB representing different information spaces concurrently. For example device 107f runs SIB 805g which represents information space 113b and at the same time runs the SIB 805h that represents information space 113a.

The system can be implemented on various platforms including mobile devices, personal computers, etc. The main requirement of such implementation platforms is that the devices support the runtime environments and that enough processing power and storage is available. Given that knowledge processors 801a-801j can be distributed over devices with more processing power and/or storage as necessary, usually smaller hand-held devices are adequate for running these knowledge processors.

In one embodiment, a SIB 805a-805h may run on systems supporting the Python runtime environment and additionally versions for C++ specifically exist for Linux/Unix and Open-C for Symbian operating system. Client libraries for knowledge processors 801a-801j may exist in Python, C, C++(Linux/Unix and Symbian) as well as Java. Other environments based on Web services and Javascript can also be used.

In another embodiment, the system implementations run on Mobile Devices (including: N800/810, N95) and personal computers (Unix, Linux, Windows). The knowledge processors 801a-801j can run on sensors, etc. Communication is made over TCP/IP and HTTP protocols which can be used over Ethernet, GPRS and 3G transports.

The information spaces 113a-113m can be represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. For example, RDF is a family of World Wide Web Consortium (W3C) specifications originally designed as a metadata data model. RDF has come to be used as a general method for conceptual description or modeling of information that is implemented in web resources; using a variety of syntax formats. The underlying structure of any expression in RDF is a collection of triples, each consisting of three disjoint sets of nodes including a subject, a predicate and an object. A subject is an RDF Uniform Resource Identifier (URI) reference (U) or a Blank Node (B), a predicate is an RDF URI reference (U), and an object is an RDF URI reference (U), a literal (L) or a Blank Node (B). A set of such triples is called an RDF graph. Table 1 shows sample RDF triples.

TABLE 1

| Subject | Predicate | Object |
|---|---|---|
| uri://. . ./rule#CD-introduction, | rdf:type, | uri://. . ./ |
| | | Rule |
| uri://. . ./rule#CD-introduction, | uri://. . ./rule#assumption, | “c” |

The basic operations on an information store are insertion of a graph, retraction (deletion) of a graph, querying and subscription for information. Insertion and retractions may be combined into a single transactional structure in order to admit atomic updates through the atomic application of retract and insert. All other forms of operations are constructions and refinements of the above. For example, update is constructed out of a set of retracts and inserts. Further rewrite rules can simplify the recurrent application of operations.

In one embodiment, a query is evaluated based on the current snapshot of the information in the information space 113a-113m. Queries can be performed by Wilbur query language (WQL) or simple RDF triple pattern matching. WQL is a lisp-like path based query language. One important difference between WQL and RDF triple pattern matching is that Wilbur's static reasoning engine only runs with WQL queries. WQL queries return a set of RDF graph nodes, while the pattern queries return an RDF graph. Furthermore, other query languages such as SPARQL are also supported.

In another embodiment, subscriptions are implemented as persistent queries, that is, a given query is evaluated whenever the information in the information space 113a-113m changes, and thus the same methods are available. The results are transmitted to the knowledge processors 801a-801j only when they are changed. Depending on parameters, either the full results or a differential is transmitted.

According to the stated ontologies, no attempt is made by the information space 113a-113m to enforce consistency or integrity of information. However, internal reasoning knowledge processors (not shown) may be present which can perform this activity if the information space 113a-113m has been configured accordingly. Information is explicitly semi-structured and may take on any form that the knowledge processors 801a-801j insert or retract.

Presence of typing constructs and namespaces does not necessarily mean that a knowledge processor 801 querying for that information will interpret the information according to the implied ontology. A namespace is an abstract container or environment created to hold a logical grouping of unique identifiers or symbols (e.g. names). The semantics of the information is interpreted by the reader, merely implied by the writer and grounded in the real world context of the knowledge processors 801a-801j. Therefore, any two given knowledge processors may disagree about the semantics. This concept is generally referred to as pragmatic or intentional semantics.

The information spaces 113a-113m provide further functionality regarding the joining and leaving of knowledge processors 801a-801j and policy management. Knowledge processors 801a-801j have a set of credentials which are passed during the “join” operation. The counterparts of the knowledge processor 801a-801j instantiated “leave” and “join” operations are the information spaces 113a-113m instantiated “invite” and “remove” operations. These operations are not necessarily provided by every information space 113a-113m nor understood by every knowledge processor 801a-801j.

Connectivity is provided through a set of listeners which provide access via any given specified transport protocol. TCP/IP is the most used transport, but a Bluetooth based listener or one that uses HTTP/S have also been developed. Listeners can provide pre-processing of the incoming messages if necessary; for example with Bluetooth profiles. Any number of listeners may be provided at any time (at least one is necessary).

Furthermore and in some respects similar to that of the principles of information distribution, the connectivity of an information space 113a-113m can also be seen as a union of all listeners in all SIBs 805a-805h. However, not all listeners may be available on all physical locations (consider Bluetooth or TCP/IP over WLAN for example).

In one embodiment, the cognitive radio spectrum reservation platform 103, performs the process described by the flowchart 300 of FIG. 3 to manage cognitive radio information sharing among cognitive radio enabled devices 107a-107f using the information spaces 113a-113m, wherein the information spaces 113a-113m are configured based on the architecture described in FIG. 8.

The processes described herein for providing optimized privacy in cognitive radio information sharing may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

The processes described herein for providing spectrum reservation in cognitive radio information sharing may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

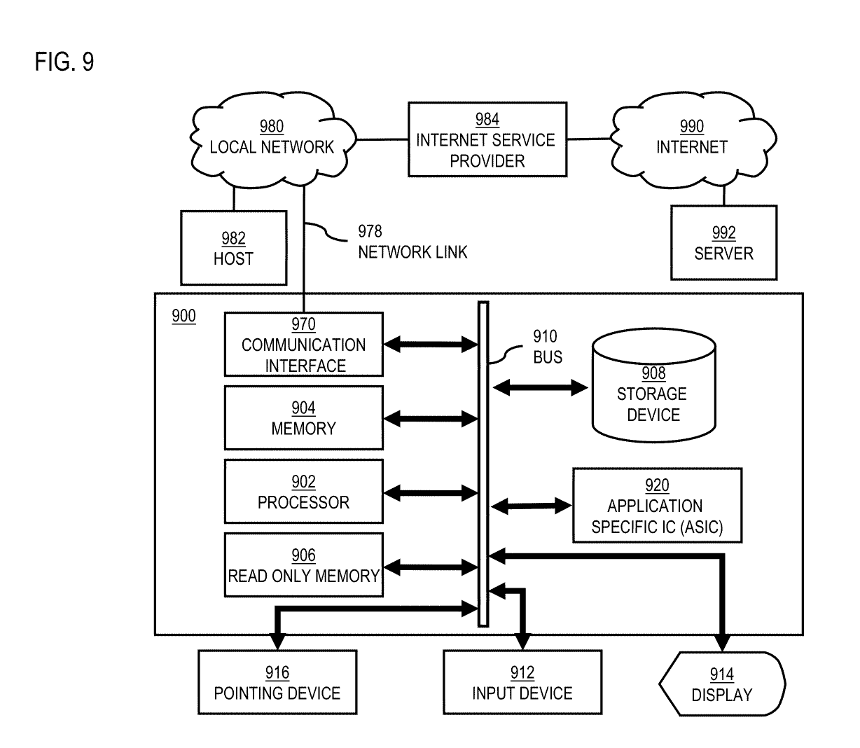

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide spectrum reservation in cognitive radio information sharing as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing spectrum reservation in cognitive radio information sharing.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing spectrum reservation in cognitive radio information sharing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing spectrum reservation in cognitive radio information sharing. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing spectrum reservation in cognitive radio information sharing, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing spectrum reservation in cognitive radio information sharing to the UEs 107a-107i.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide spectrum reservation in cognitive radio information sharing as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing spectrum reservation in cognitive radio information sharing.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide spectrum reservation in cognitive radio information sharing. The memory 1005 also stores the data associated with or generated by the execution of the inventive steps.

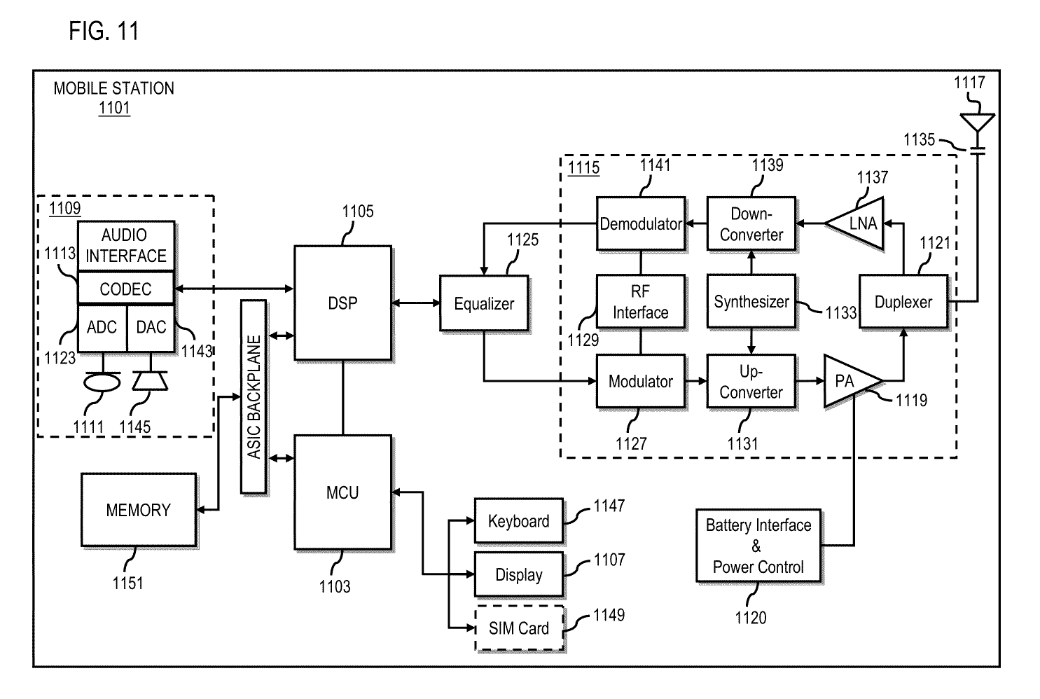

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing spectrum reservation in cognitive radio information sharing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing spectrum reservation in cognitive radio information sharing. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide spectrum reservation in cognitive radio information sharing. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
information regarding at least one predicted location of at least one device;
a processing of the information to generate a prediction of one or more cognitive radio resources that are to be used by the at least one device at the at least one predicted location; and
a reservation of the one or more cognitive resources from one or more cognitive radio connectivity providers based, at least in part, on the prediction.

2. A method of claim 1, wherein the (1) data and/or (2) information and/or (3) at least one signal are further based, at least in part, on the following:
activity information, time information, or a combination thereof associated with the at least one device with respect to the at least one predicted location,
wherein the prediction, the reservation, or a combination thereof are based, at least in part, on the activity information, the time information, or a combination thereof.

3. A method of claim 1, wherein the (1) data and/or (2) information and/or (3) at least one signal are further based, at least in part, on the following:
navigation routing information associated with the at least one device; and
a processing of the navigation routing information to determine the at least one predicted location.

4. A method of claim 3, wherein the (1) data and/or (2) information and/or (3) at least one signal are further based, at least in part, on the following:
at least one change to the navigation routing information; and
one or more updates to the prediction, the reservation, or a combination thereof based, at least in part, on the at least one change.

5. A method of claim 3, wherein the (1) data and/or (2) information and/or (3) at least one signal are further based, at least in part, on the following:
at least one determination that the navigation routing information indicates at least one predetermined routes; and
an initiation of the prediction, the reservation, or a combination thereof based, at least in part, on the indication of the at least one or more predetermined routes.

6. A method of claim 1, wherein the prediction, the reservation, or a combination thereof are determined collectively for the at least one device.

7. A method of claim 1, wherein the reservation is requested periodically or continuously.

8. A method of claim 1, wherein the (1) data and/or (2) information and/or (3) at least one signal are further based, at least in part, on the following:
a monitoring of the one or more cognitive radio connectivity providers to determine an availability of one or more improved cognitive radio resources; and
an update of the reservation based, at least in part, on the availability of the one or more improved cognitive radio resources.

9. A method of claim 8, wherein the monitoring is performed periodically, substantially continuously, according to a schedule, on demand, or a combination thereof.

10. A method of claim 1, wherein the reservation is based, at least in part, on a bidding for the one or more cognitive radio resources.

11. An apparatus comprising:
at least one processor; and
at least one memory including computer program code for one or more computer programs,
the at least one memory and the computer program code configured to, with the at least one processor, cause the apparatus to perform at least the following,
determine information regarding at least one predicted location of at least one device;
process and/or facilitate a processing of the information to generate a prediction of one or more cognitive radio resources that are to be used by the at least one device at the at least one predicted location; and
cause, at least in part, a reservation of the one or more cognitive resources from one or more cognitive radio connectivity providers based, at least in part, on the prediction.

12. An apparatus of claim 11, wherein the apparatus is further caused to:
determine activity information, time information, or a combination thereof associated with the at least one device with respect to the at least one predicted location,
wherein the prediction, the reservation, or a combination thereof are based, at least in part, on the activity information, the time information, or a combination thereof.

13. An apparatus of claim 11, wherein the apparatus is further caused to:
determine navigation routing information associated with the at least one device; and
process and/or facilitate a processing of the navigation routing information to determine the at least one predicted location.

14. An apparatus of claim 13, wherein the apparatus is further caused to:
determine at least one change to the navigation routing information; and
cause, at least in part, one or more updates to the prediction, the reservation, or a combination thereof based, at least in part, on the at least one change.

15. An apparatus of claim 13, wherein the apparatus is further caused to:
determine that the navigation routing information indicates at least one predetermined routes; and
cause, at least in part, an initiation of the prediction, the reservation, or a combination thereof based, at least in part, on the indication of the at least one or more predetermined routes.

16. An apparatus of claim 11, wherein the prediction, the reservation, or a combination thereof are determined collectively for the at least one device.

17. An apparatus of claim 11, wherein the reservation is requested periodically or continuously.

18. An apparatus of claim 11, wherein the apparatus is further caused to:
cause, at least in part, a monitoring of the one or more cognitive radio connectivity providers to determine an availability of one or more improved cognitive radio resources; and
cause, at least in part, an update of the reservation based, at least in part, on the availability of the one or more improved cognitive radio resources.

19. An apparatus of claim 18, wherein the monitoring is performed periodically, substantially continuously, according to a schedule, on demand, or a combination thereof.

20. An apparatus of claim 11, wherein the reservation is based, at least in part, on a bidding for the one or more cognitive radio resources.

21.-48. (canceled)
